(19) United States
(12) Patent Application Publication
(10) Pub. No.: US 2014/0125610 A1
(43) Pub. Date: May 8, 2014

(54) TOUCH SCREEN PANEL

(71) Applicant: SAMSUNG DISPLAY CO., LTD., YONGIN-CITY (KR)

(72) Inventor: Jeong-Seok Oh, Yongin-City (KR)

(21) Appl. No.: 14/063,721

(22) Filed: Oct. 25, 2013

(30) Foreign Application Priority Data
Nov. 7, 2012 (KR) 10-2012-0125483

(51) Int. Cl. G06F 3/041; G06F 3/045; G06F 3/044

(52) U.S. Cl. CPC G06F 3/0412; G06F 3/044; G06F 3/045
USPC 345/173

(57) ABSTRACT

A touch screen panel includes a window, a light source portion, a touch key circuit board and a touch sensing portion. The window has a touch key area on which a touch key icon is displayed, and has a recessed portion formed adjacent to the touch key area in a first surface thereof. The light source portion is disposed inside the recessed portion so as to emit light. The touch key circuit board has the light source portion mounted thereon. The touch sensing portion is formed between the window and the touch key circuit board, geometrically corresponding to the touch key area.

### CLAIM OF PRIORITY

This application makes reference to, incorporates the same herein, and claims all benefits accruing under 35 U.S.C. §119 from an application earlier filed in the Korean Intellectual Property Office on 7 Nov. 2012 and there duly assigned Serial No. 10-2012-0125483.

### BACKGROUND OF THE INVENTION

1. Field of the Invention

An aspect of the present invention relates to a touch screen panel, and more particularly, to a touch screen panel having a touch key area for a user's key input.

2. Description of the Related Art

A touch screen panel is an input device that allows a user's instruction to be input by selecting an instruction content displayed on a screen of an image display device or the like with a user's hand or object.

To this end, the touch screen panel is formed on a front face of the image display device to convert a contact position into an electrical signal. Here, the user's hand or object is in direct contact with the touch screen panel at the contact position. Accordingly, the instruction content selected at the contact position is input as an input signal to the image display device.

Since such a touch screen panel can be substituted for a separate input device connected to an image display device, such as a keyboard or mouse, its application fields have been gradually extended.

In the touch screen panel, a sensing electrode is formed in a display area on which an image is displayed, thereby recognizing a touch event occurring in the display area as an input signal. That is, in case of an image display device having the touch screen panel, the display area is a display area on which an image is displayed, and is simultaneously set as a touch active area on which a touch input is possible.

In this case, a functional key such as a menu key or screen conversion key is implemented in the form of a touch key so as to promote user's convenience. The touch key may be implemented by performing a separate coating or printing process, a film attaching process, etc.

In case of a portable terminal such as a smart phone, a touch key icon is generally positioned at a lower end of a display area, and a touch key module including a light source and a light guiding plate is disposed on a rear surface of a window glass formed on the front surface of the portable terminal.

Currently, the portable terminal tends to pursuit a slimmer shape. However, as the light source and the light guiding plate are disposed on the rear surface of the window glass, the thickness of the touch screen panel is essentially increased. Therefore, the internal design of the portable terminal is limited.

In a contemporary touch screen panel having a touch key module, the touch key module is disposed in the same layer as a resin layer for allowing a main touch panel to be adhered to a window glass. Therefore, the touch key module blocks UV irradiation for resin curing.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a touch screen panel capable of decreasing the thickness of a touch key module.

In accordance with an aspect of the present invention a touch screen panel may include a window having a touch key area on which a touch key icon is displayed, and having a recessed portion formed adjacent to the touch key area in a first surface thereof; a light source portion disposed inside the recessed portion so as to emit light; a touch key circuit board having the light source portion mounted thereon; and a touch sensing portion formed between the window and the touch key circuit board, corresponding to the touch key area.

A first optical pattern for guiding the light emitted from the light source portion to the touch key area may be formed on the first surface of the window.

The first optical pattern may be formed through a cutting or stamping process.

The window may further include an enlarged recessed portion in which the recessed space of the recessed portion is enlarged in the opposite direction of the touch key area.

The light source portion or a driving circuit of the touch sensing portion may be disposed inside the enlarged recessed portion.

A second optical pattern may be formed on one surface toward the touch key area in the inner wall of the recessed portion.

The touch key circuit board may be fixed to the first surface of the window using a double-face adhesive tape.

The recessed portion may be formed through a cutting or injection molding process.

A light shielding printed layer having the touch key icon printed thereon may be formed on a second surface opposite to the first surface of the window.

As described above, in accordance with the present invention, a recessed portion is formed in the rear surface of a window, and a light source portion is disposed inside the recessed portion, so that it is possible to provide a touch key module having a decreased thickness without using a light guide plate. Accordingly, it is possible to implement the slimness of the touch screen panel.

Further, as the thickness of the touch key module decreases, the resin curing operation using UV irradiation may be easily performed.

Further, the recessed space of the recessed portion is enlarged, thereby maximizing the use of space.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a plan view schematically showing a touch screen panel according to an embodiment of the present invention.

FIG. 2 is a cross-sectional view of a main part of the touch screen panel taken along line I-I′ of FIG. 1.

FIG. 3 is a cross-sectional view showing a modified embodiment of the touch screen panel shown in FIG. 2.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, embodiments of the present invention will be described in detail with reference to the accompanying drawings.

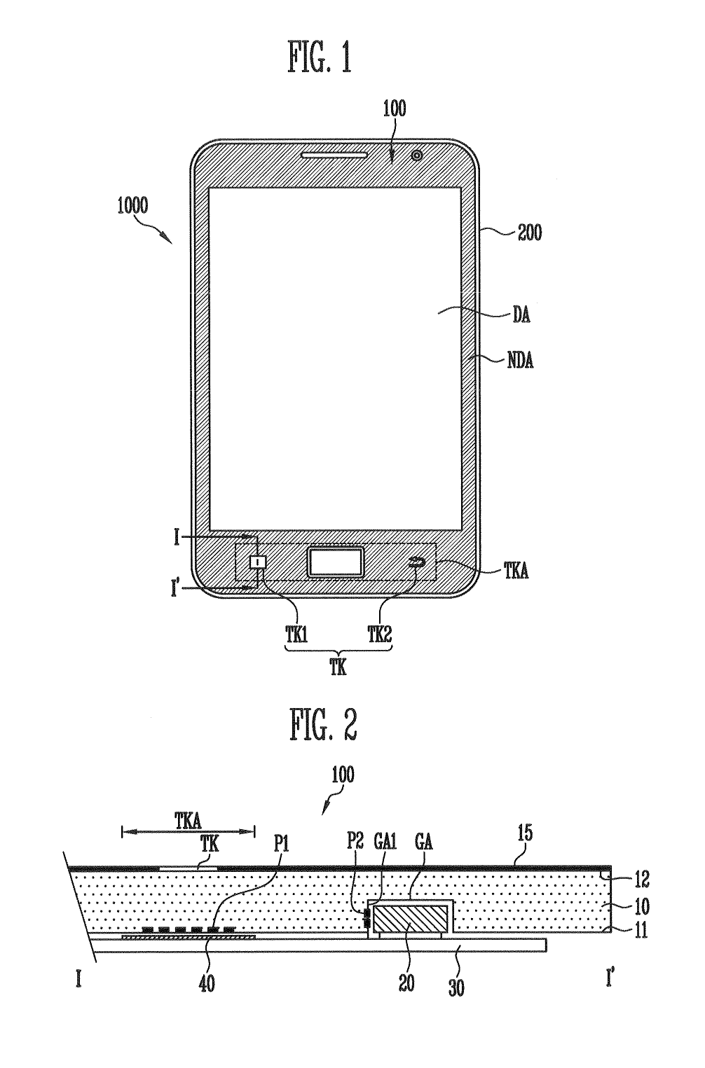

FIG. 1 is a plan view schematically showing a touch screen panel according to an embodiment of the present invention.

In reference to FIG. 1, the touch screen panel 100 according to this embodiment may be provided in a portable terminal 1000 having a touch key area TKA for inputting a user's key in a partial region of a window panel.

Here, the portable terminal 1000 may include not only a smart phone and a personal digital assistant but also a handheld PC, a web PAD, etc.

For convenience of illustration, a smart phone has been described as the portable terminal 1000 in this embodiment. However, in other embodiments, the portable terminal 1000 may be replaced with various user terminals such as a personal computer and a notebook computer.

The touch screen panel 100 is accommodated in a case 200, and may have an approximately rectangular plate shape. The window panel formed at the front of the touch screen panel 100 may be formed of a glass material having optical transparency or synthetic resin such as acryl.

A display area DA, a non-display area NDA formed at the outside of the display area DA, and the touch key area TKA disposed in a portion of the non-display area NDA are defined in the touch screen panel 100.

The display area DA is set as an area on which an image is displayed, and simultaneously as a touch active area on which a touch input is possible.

The touch screen panel 100 is classified into a resistive type, a capacitive type, a surface acoustic wave type and an infrared type so as to sense a touch position.

The non-display area NDA is a light shielding area of an opaque color, e.g., a blue color, which is formed along an edge of the display area DA, and has a shape surrounding the display area DA on which an image is displayed.

The trademark of a cellular phone, the logo of a communication company, etc. is printed on the non-display area NDA. The non-display area NDA also functions to cover a conductive pattern at the outside of a touch electrode formed on the display area DA.

The non-display area NDA may be formed on the window panel using one selected from a printing method, a shadow mask method and a photolithography method.

In the touch screen panel 100 according to this embodiment, the touch key area TKA on which functional keys such as a menu key TK1 and a screen conversion key TK2 are implemented in the form of a touch key TK is provided at a portion of the non-display area NDA as the light shielding area.

The touch key TK may be printed using a method in which a touch key icon symbolizing the function of a corresponding key is designed so that the light shielding area is removed.

Here, the configuration and shape of the touch key TK are not limited to the embodiment described above, and may be changed when necessary.

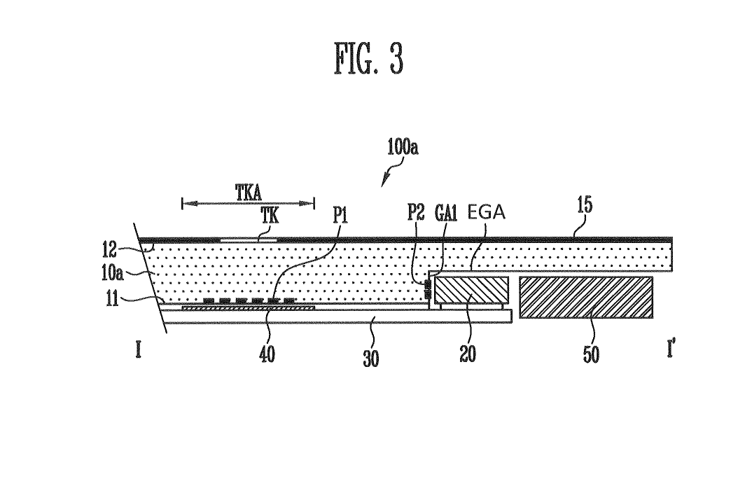

FIG. 2 is a cross-sectional view of a main part of the touch screen panel taken along line I-I′ of FIG. 1.

In reference to FIG. 2, the touch screen panel 100 according to this embodiment includes a window 10, a light source unit 20, a touch key circuit board 30 and a touch sensing portion 40.

A display panel (not shown) disposed below the display area DA of the touch screen panel 100 may be configured as an organic light emitting display (OLED) panel or liquid crystal display (LCD) panel integrated with a touch screen. The configuration of the display panel is well known in the art, and therefore, its detailed description will be omitted.

The window 10 is positioned at the uppermost end of the touch screen panel 100, and may be formed using a transparent substrate material such as glass, polyethylene terephthalate (PET) or acryl.

The window 10 has a recessed portion GA obtained by forming a groove adjacent to the touch key area TKA in a first surface 11 toward the inside of the touch screen panel 100.

The recessed portion GA is a space in which the light source portion 20 described later is inserted and disposed. The recessed portion GA may have a size and a shape, corresponding to those of the light source portion 20.

In this embodiment, the recessed portion GA is formed at the outer region of the touch screen panel 100. However, in other embodiments, the recessed portion GA may be disposed in any one of top, bottom, left and right directions about the touch key area TKA in the non-display area NDA.

The recessed portion GA may be formed through a cutting or injection molding process according to the material of the window 10.

For example, in a case where the window 10 is made of a glass material, the recessed portion GA may be formed through an injection molding process using a mold.

Meanwhile, a light shielding printed layer 15 having the touch key icon printed thereon is formed on a second surface 12 opposite to the first surface 11.

As described above, the light shielding printed layer 15 may be formed by one selected from the printing method, the shadow mask method and the photolithography method, using an opaque colored material for forming the non-display area NDA.

Here, the light shielding printed layer 15 is opened along the pattern of the touch key icon, and light emitted from the light source portion positioned at a lower end of the window 10 is transmitted through the light shielding printed layer 15, thereby displaying the touch key TK.

In some embodiments, a first optical pattern P1 for guiding the light emitted from the light source portion 20 to the touch key area TKA may be formed on the first surface 11 of the window 10.

The first optical pattern P1 is used to concentrate the light emitted from the light source portion 20 on the touch key area TKA by forming a fine optical pattern directly on the surface of the window 10. The first optical pattern P1 may have an irregularity pattern such as a fine prism. In addition, the first optical pattern P1 may have various patterns.

The first optical pattern P1 may be formed to have a width corresponding to or wider than the touch key area TKA.

In some embodiments, a second optical pattern P2 may be formed on one surface GA1 toward the touch key area TKA in the inner wall of the recessed portion GA. The second optical pattern P2 may be formed on a surface of the inner side wall of the recessed portion GA with the surface being disposed closest to the touch key area TKA among all the surfaces of the inner side wall of the recessed portion GA.

The second optical pattern P2 is used to improve optical characteristics of the light emitted from the light source portion 20 by forming a fine optical pattern directly on the surface of the window 10. The second optical pattern P2 may have an irregularity pattern such as a fine prism. In addition, the second optical pattern P2 may have various patterns.

The first and second optical patterns P1 and P2 may be formed through a cutting or stamping process according to the material of the window 10.

For example, the window 10 made of a plastic material may be formed by filling a raw material in a window manufacturing mold, solidifying the filled material and then ejecting the solidified material from the mold. Here, a stamper having molding patterns formed therein may be used to form the optical patterns on the window 10.

In another embodiment, an optical sheet or metal pattern may be may be used in place of the optical patterns formed directly on the window 10.

The present invention is not limited thereto, and various mechanical or chemical treatments may be performed on the window 10 in order to improve optical efficiency.

The light source portion 20 is disposed inside the recessed portion GA so as to emit light. For example, the light source portion 20 may be a light emitting diode (LED) lamp, but the present invention is not limited thereto. That is, various kinds of light sources for emitting light may be used as the light source portion 20.

The touch key circuit board 30 is a circuit board having the light source portion 20 mounted thereon. The touch key circuit board 30 may be a flexible printed circuit board using a thin plastic film such as polyester (PET) or polyimide (PI).

Here, the touch key circuit board 30 may be fixed to the first surface 11 of the window 10 using a double-faced adhesive tape (not shown).

The touch sensing portion 40 is formed on the touch key circuit board 30, geometrically corresponding to and facing the touch key area TKA.

The touch sensing portion 40 may be formed of not only a transparent electrode material such as indium-tin-oxide (ITO) but also an electrically conductive material such as molybdenum (Mo), silver (Ag), titanium (Ti), copper (Cu), aluminum (Al) or molybdenum/aluminum/molybdenum (Mo/Al/Mo).

The touch sensing portion 40 may be formed by sputtering or depositing the electrically conductive material, etc. on the touch key circuit board 30. Alternatively, the touch sensing portion 40 may be adhered on the first surface 11 of the window 10 using an adhesive or double-faced tape. In addition, the touch sensing portion 40 may be formed or adhered on the first surface 11 of the window 10 using various methods.

The capacitive type, resistive type, the surface acoustic wave type and the infrared type may be used as the touch sensing type of the touch screen panel 100. In the capacitive type frequently used, a contact position is converted into an electrical signal by sensing a change in capacitance formed between a conductive sensing pattern and an adjacent sensing pattern, ground electrode or the like when a user's hand or object is in contact with the touch screen panel.

As described above, according to the present invention, the recessed portion GA is formed in the rear surface of the window 10, and the light source portion 20 is disposed inside the recessed portion GA, so that it is possible to a touch key module having a decreased thickness without using a light guide plate. Accordingly, it is possible to implement the slimness of the touch screen panel.

In the contemporary touch screen panel, it is difficult to cure a resin adhesive layer positioned on the same layer as the touch key module by irradiating UV light onto the side of the resin adhesive layer.

However, according to the present invention, the path of light is ensured as the thickness of the touch key module decreases, and thus the resin curing operation using UV irradiation can be easily performed.

FIG. 3 is a cross-sectional view showing a modified embodiment of the touch screen panel shown in FIG. 2.

In FIG. 3, as far as reference is made to identical components, the same reference numerals as in the case of the preceding embodiment will be used and the above description will be referred to, and their detailed descriptions will be omitted to avoid redundancy.

In reference to FIG. 3, the touch screen panel 100a according to the modification further includes an enlarged recessed portion EGA in which the recessed space of the recessed portion GA is enlarged in the opposite direction of the touch key area (TKA) in the window 10.

The enlarged recessed portion EGA may be formed by enlarging the groove long in the direction opposite to one surface GA1 toward the touch key area TKA in the inner wall of the recessed portion GA.

The region on which the enlarged recessed portion EGA is positioned is the outermost region on the non-display area NDA of the touch screen panel 100a, and thus does not have influence on the display quality of the display area DA or touch key area TKA. The enlarged recessed portion EGA may be disposed in immediate contact with the outermost periphery of the window 10.

Like the recessed portion having the light source portion disposed therein, another component, e.g., the light source portion 20 or a driving circuit 50 of the touch sensing unit 40 may be disposed inside the enlarged recessed portion EGA, thereby maximizing the use of space.

The method of forming the enlarged recessed portion EGA is the same as the method of forming the recessed portion GA, and the size and shape of the enlarged recessed portion EGA may be variously modified.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel, comprising:
a window having a touch key area on which a touch key icon is displayed, and having a recessed portion formed adjacent to the touch key area in a first surface of the window;
a light source portion disposed inside the recessed portion so as to emit light;
a touch key circuit board having the light source portion mounted thereon; and
a touch sensing portion formed between the window and the touch key circuit board, the touch sensing portion disposed geometrically corresponding to the touch key area.

2. The touch screen panel of claim 1, wherein a first optical pattern for guiding the light emitted from the light source portion to the touch key area is formed on the first surface of the window.

3. The touch screen panel of claim 2, wherein the first optical pattern is formed through a cutting or stamping process.

4. The touch screen panel of claim 1, wherein the window further includes an enlarged recessed portion in which the recessed space of the recessed portion is enlarged in the opposite direction of the touch key area.

5. The touch screen panel of claim 4, wherein the light source portion or a driving circuit of the touch sensing portion is disposed inside the enlarged recessed portion.

6. The touch screen panel of claim 1, wherein a second optical pattern is formed on one surface toward the touch key area in the inner wall of the recessed portion.

7. The touch screen panel of claim 1, wherein the touch key circuit board is fixed to the first surface of the window using a double-face adhesive tape.

8. The touch screen panel of claim 1, wherein the recessed portion is formed through a cutting or injection molding process.

9. The touch screen panel of claim 1, wherein a light shielding printed layer having the touch key icon printed thereon is formed on a second surface opposite to the first surface of the window.
